(19) United States
(12) Patent Application Publication
(10) Pub. No.: US 2026/0115870 A1
(43) Pub. Date: Apr. 30, 2026

(54) POWERED RATCHET WRENCH WITH HERRINGBONE TEETH

(71) Applicant: MILWAUKEE ELECTRIC TOOL CORPORATION, Brookfield, WI (US)

(72) Inventors: Jacob P. Schneider, Cedarburg, WI (US); Kyle Marten, Plymouth, WI (US)

(21) Appl. No.: 19/081,568

(22) Filed: Mar. 17, 2025

Related U.S. Application Data
(60) Provisional application No. 63/565,690, filed on Mar. 15, 2024.

(51) Int. Cl. B25B 21/00

(52) U.S. Cl. CPC B25B 21/004; B25B 21/002

(57) ABSTRACT

A powered ratchet tool includes a housing having a head portion, a motor, a drive assembly including an output configured to be driven by the motor, a yoke supported within the head portion and coupled to the output of the drive assembly such that the yoke is configured to reciprocate about an axis in response to rotation of the output, and a drive supported by the yoke. The drive includes a first plurality of herringbone teeth on an outer periphery of the drive. A pawl includes a second plurality of herringbone teeth configured to engage the first plurality of herringbone teeth to rotate the drive together with the yoke in a first direction about the axis and to slide over the first plurality of herringbone teeth such that the yoke is rotatable relative to the drive in a second direction about the axis.

### CROSS-REFERENCE TO RELATED APPLICATIONS

This application claims priority to U.S. Provisional Patent Application No. 63/565,690, filed Mar. 15, 2024, the entire content of which is incorporated herein by reference.

### FIELD

The present disclosure relates to ratchet tools, and more particularly, to a ratchet assembly and drive assembly of a box ratchet.

### BACKGROUND

Box ratchets may facilitate tightening or loosening a fastener in a confined space where rotation of a tool about a 360 degree axis cannot be undertaken. To that end, a ratchet assembly of a box ratchet provides for tightening of a fastener in one rotational direction while allowing free rotation of the box ratchet in the opposite direction, thereby providing uni-directional tightening of the fastener without subsequently loosening the fastener as the box ratchet is rotated in the opposite direction, without having to disengage the box ratchet from the fastener to continue the fastening operation.

### SUMMARY

In some aspects, the techniques described herein relate to a powered ratchet tool including: a housing including a head portion; a motor; a drive assembly including an output configured to be driven by the motor; a yoke supported within the head portion and coupled to the output of the drive assembly such that the yoke is configured to reciprocate about an axis in response to rotation of the output; a drive supported by the yoke, the drive including a first plurality of herringbone teeth on an outer periphery of the drive; and a pawl including a second plurality of herringbone teeth configured to engage the first plurality of herringbone teeth to rotate the drive together with the yoke in a first direction about the axis and to slide over the first plurality of herringbone teeth such that the yoke is rotatable relative to the drive in a second direction about the axis.

In some aspects, the techniques described herein relate to a powered ratchet tool including: a housing including a head portion; a motor; a drive assembly including an output configured to be driven by the motor; a yoke supported within the head portion and coupled to the output of the drive assembly such that the yoke is configured to reciprocate about an axis in response to rotation of the output; a drive supported by the yoke, the drive including a first plurality of herringbone teeth on an outer periphery of the drive; a first pawl including a second plurality of herringbone teeth configured to engage the first plurality of herringbone teeth to rotate the drive together with the yoke in a first direction about the axis; and a second pawl including a third plurality of herringbone teeth configured to engage the first plurality of herringbone teeth to rotate the drive together with the yoke in a second direction about the axis.

In some aspects, the techniques described herein relate to a powered ratchet tool including: a housing including a head portion; a motor; a drive assembly including an output configured to be driven by the motor; a yoke supported within the head portion and coupled to the output of the drive assembly such that the yoke is configured to reciprocate about an axis in response to rotation of the output; a drive supported by the yoke, the drive including a first plurality of herringbone teeth on an outer periphery of the drive and an interior defining an insertion hole, the insertion hole being a through-hole extending entirely through the drive; and a first pawl including a second plurality of herringbone teeth configured to engage the first plurality of herringbone teeth to rotate the drive together with the yoke in a first direction about the axis.

Other features and aspects of the invention will become apparent by consideration of the following detailed description and accompanying drawings.

### BRIEF DESCRIPTION OF THE DRAWINGS

FIG. 1 is a perspective view of a powered ratchet wrench embodying aspects of the present disclosure.

FIG. 2 is cross sectional view of the powered ratchet wrench of FIG. 1.

FIG. 3 is perspective view of a head portion of the powered ratchet wrench of FIG. 1.

FIG. 4 is a cross-sectional view of the head portion of FIG. 3, through section line 4-4.

FIG. 5 is a perspective view of a drive of the powered ratchet wrench of FIG. 1.

FIG. 6 is a perspective view of a pawl of the powered ratchet wrench of FIG. 1.

FIG. 7 is a schematic of a first angle formed between an upper row of teeth with a drive groove of the drive of FIG. 5 and a pawl groove of FIG. 6.

FIG. 8 is a schematic of a second angle formed between a lower row of teeth with a drive groove of the drive of FIG. 5 and a pawl groove of FIG. 6.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

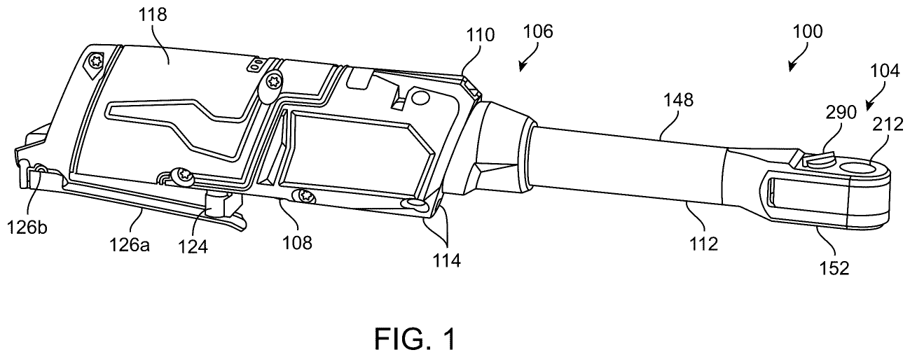

FIG. 1 illustrates a power tool in the form of a powered ratchet tool 100 configured to rotate a fastener in clockwise and counterclockwise directions via an output assembly 104. The tool 100 includes a housing 106 having a handle portion 108, a motor housing 110 coupled to and supported by the handle portion 108, and a yoke housing 112 extending from the motor housing 110. The illustrated handle portion 108 includes a pair of clamshell halves 114. The handle portion 108 also includes a grip 118 that is formed by a resilient material (e.g., rubber, silicone, or the like) over molded on the clamshell halves 114. The handle portion 108 is configured to be grasped by a user during operation of the tool 100. As illustrated, the motor housing 110 and the yoke housing 112 are formed separately and coupled together, although the motor housing 110 and yoke housing 112 may instead be integrally formed.

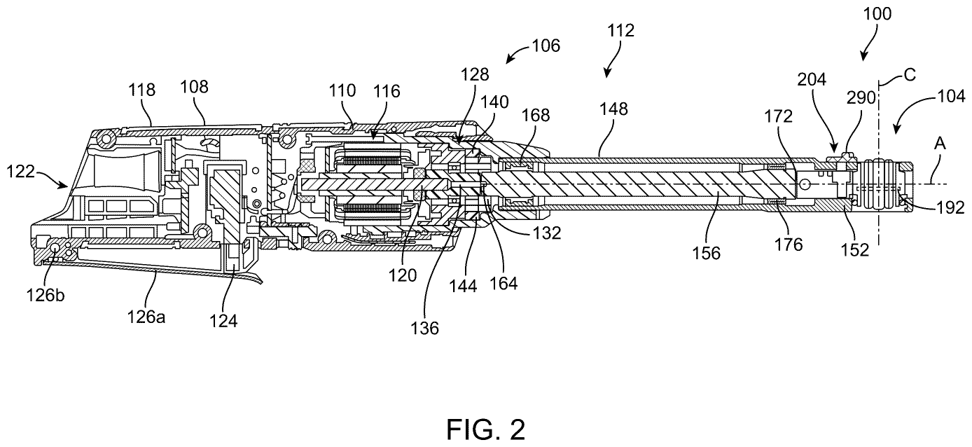

With continued reference to FIG. 1, a battery pack (not shown) is removably coupled to the housing 106 and, in the illustrated embodiment, is received by the handle portion 108. In particular, the battery pack can be inserted into and removed from a cavity 122 (FIG. 2) in the handle portion 108. The battery pack may be a removable and rechargeable 12-volt battery pack and includes three (3) Lithium-ion battery cells. In other constructions, the battery pack may include fewer or more battery cells, different chemistries, and/or different output voltages.

With reference to FIG. 2, the motor housing 110 encloses a motor 116 having a rotor or motor shaft 120 rotatable about a first axis A when the motor 116 is energized by a switch 124 (e.g., trigger, actuator, etc.). The switch 124 is coupled to the motor housing 110 and is electrically coupled to the motor 116 (e.g., through circuitry of the switch 124 or through a control system receiving an input from the switch 124). In the illustrated embodiment, a switch paddle 126a is coupled to the handle portion 108 by a rod 126b. The switch paddle 126a pivots about the rod 126b when manipulated by a user. When the switch paddle 126a is depressed toward the handle portion 108, the switch 124 is compressed to energize the motor 116. An elastic member (not shown) engages with the switch 124 to bias the switch 124 and the switch paddle 126a away from the handle portion 108.

With continued reference to FIG. 2, the motor housing 110 includes a drive assembly 128 coupled to the motor shaft 120 of the motor 116. In the illustrated embodiment, the drive assembly 128 is a planetary transmission including a pinion 136 (which may be integral with the motor shaft 120), a plurality of planet gears 140 meshed with the pinion 136, and a ring gear 144 meshed with the planet gears 140 such that rotation of the pinion 136 causes the planet gears 140 to orbit about an inner periphery of the ring gear 144. The drive assembly 128 includes an output 132, which in the illustrated embodiment is a planetary carrier coupled to the planet gears 140 (e.g., by pins). However, other types of drive assemblies may be used, and in some embodiments, the motor shaft 120 itself may define the output 132 of the drive assembly 128.

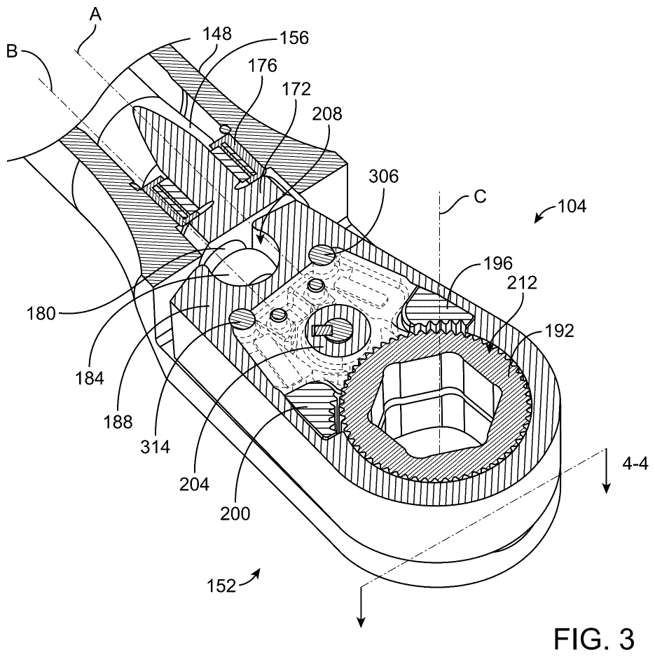

The yoke housing 112 defines an elongated extension portion 148 and a head portion 152. The elongated extension portion 148 extends from the motor housing 110 to the head portion 152. The elongated extension portion 148 includes a crankshaft 156 co-axial with the first axis A between a first end 164 and a second end 172. The first end 164 is coupled to the output 132, such that rotation from the drive assembly 128 may be transmitted to the crankshaft 156. The crankshaft 156 is supported by a first bearing 168 near the first end 164 and a second bearing 176 near the second end 172. As seen in FIG. 3, the second end 172 of the crankshaft 156 includes an eccentric pin 180 defining a second axis B. The eccentric pin 180 co-rotates with the crankshaft 156 due to rotation transmitted from the output 132. A drive bushing 184 is coupled to the eccentric pin 180 and received into the head portion 152.

With reference to FIG. 3, the head portion 152 supports the output assembly 104 for rotating a fastener about a third axis C perpendicular to the first axis A. The output assembly 104 includes a yoke 188, a drive 192, a left pawl 196, a right pawl 200, and a shuttle assembly 204. The yoke 188 includes an eccentric recess 208 and a drive recess 212. The eccentric pin 180 and the drive bushing 184 are press-fit into the eccentric recess 208 and due to the eccentric position of the eccentric pin 180 (i.e., offset from the first axis A), rotation of the crankshaft 156 about the first axis A causes the yoke 188 to pivotally reciprocate about the third axis C.

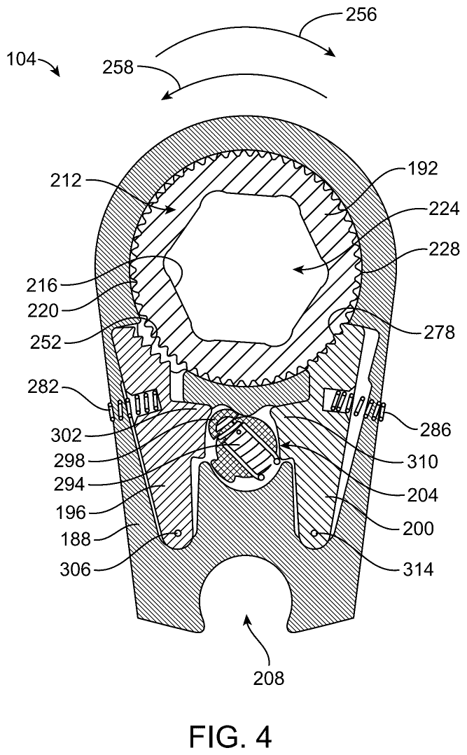

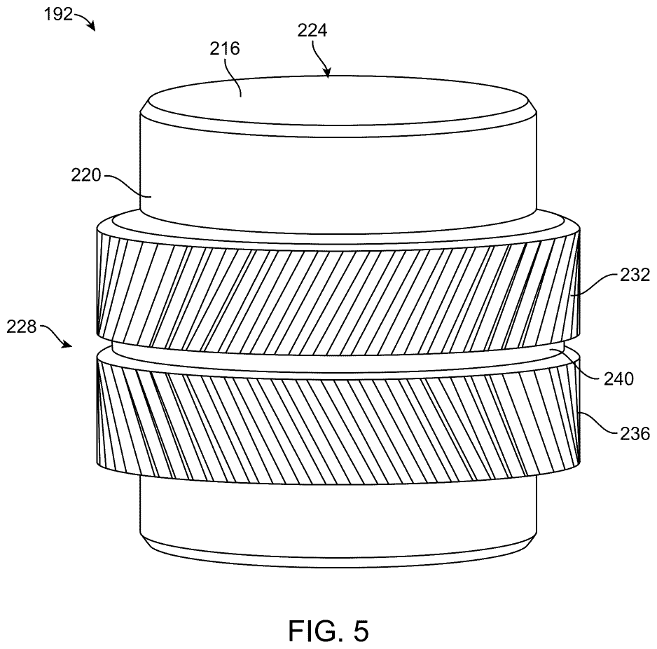

With reference to FIGS. 4-5, the drive 192 is received into the drive recess 212 of the yoke 188. The drive 192 defines an interior 216 and an exterior or outer periphery 220. The interior 216 of the drive 192 defines an insertion hole 224 having a hexagonal cross-section. In other embodiments, the insertion hole 224 may have a different cross section. The insertion hole 224 is configured to receive an accessory (e.g., a tool bit; not shown) engageable with a fastener to rotate and drive a fastener during operation of the tool 100. In some embodiments, the insertion hole 224 may be configured to directly receive and drive the fastener. In the illustrated embodiment, the insertion hole 224 is a through-hole extending entirely through the drive 192 along the third axis C.

Referring to FIG. 5, the outer periphery 220 of the drive 192 includes a plurality of drive teeth 228. The drive teeth 228 are configured as herringbone teeth having an upper row of teeth 232 and a lower row of teeth 236. Between the upper row of teeth 232 and the lower row of teeth 236 is a drive groove 240 separating the upper row of teeth 232 from the lower row of teeth 236.

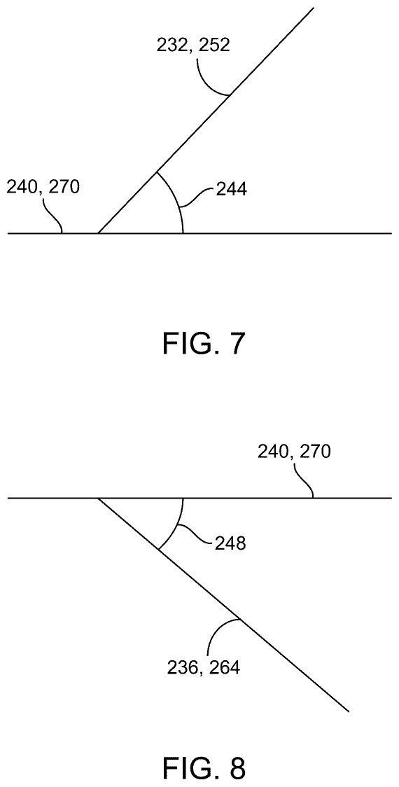

With reference to FIG. 5, each tooth of the upper row of teeth 232 forms a first angle 244 (FIG. 7) with the drive groove 240. The first angle 244 is an interior angle measuring less than 90 degrees with the drive groove 240. Each tooth of the lower row of teeth 236 forms a second angle 248 (FIG. 8) with the drive groove 240. The second angle 248 is an interior angle measuring less than 90 degrees with the drive groove 240. The first angle 244 and the second angle 248 are equal in magnitude (i.e., congruent) in the illustrated embodiment, such that the upper row of teeth 232 and the lower row of teeth 236 are symmetrical across the drive groove 240. The plurality of drive teeth 228 are configured to mesh with the left pawl 196 and the right pawl 200 to rotate the drive 192.

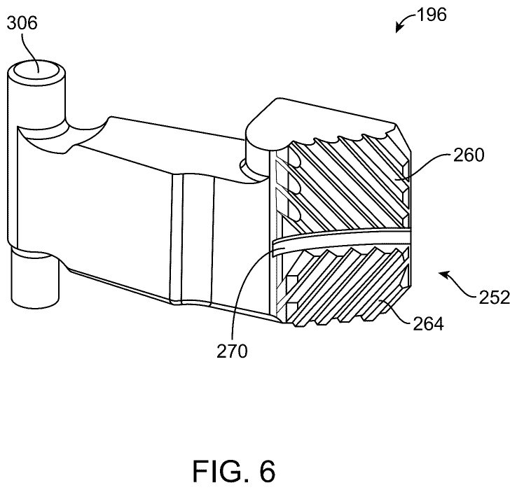

With reference to FIGS. 4 and 6, the left pawl 196 includes a first plurality of pawl teeth 252 to mesh with the plurality of drive teeth 228 to actuate the drive 192 in a first direction 256 about axis C. As seen in FIG. 6, the first plurality of pawl teeth 252 are configured as herringbone teeth having an upper row of teeth 260 and a lower row of teeth 264 separated by a left pawl groove 270. Each tooth of the upper row of teeth 260 forms the first angle 244 (FIG. 7) with the left pawl groove 270. The first angle 244 defines an interior angle measuring less than 90 degrees with the left pawl groove 270. Each tooth of the lower row of teeth 264 form the second angle 248 (FIG. 8) with the left pawl groove 270. The second angle 248 defines an interior angle measuring less than 90 degrees with the left pawl groove 270. The first angle 244 and the second angle 248 are congruent angles forming the same measurement with the left pawl groove 270.

The right pawl 200 includes a second plurality of pawl teeth 278 to mesh with the plurality of drive teeth 228 to actuate the drive 192 in a second direction 258 opposite the first direction 256 about axis C. The second plurality of pawl teeth 278 are configured as herringbone teeth. The right pawl 200 is substantially identical to the left pawl 196, except that the second plurality of pawl teeth 278 are angled in an opposite direction to allow for actuation of the drive 192 about the second direction 258. The shuttle assembly 204 selectively engages the left pawl 196 or the right pawl 200 with the drive 192. The left pawl 196 includes a first biasing member 282 urging the left pawl 196 into engagement with the drive 192. The right pawl 200 includes a second biasing member 286 urging the right pawl 200 into engagement with the drive 192.

With reference to FIG. 4, the shuttle assembly 204 is housed in the yoke housing 112 and includes a knob 290, a spring 294, and a pushing member 298. The knob 290 (FIG. 2) projects from the yoke housing 112 and is pivotable by the user between a first position and a second position. In the first position as seen in FIG. 4, the spring 294 urges the pushing member 298 into engagement with a portion 302 of the left pawl 196, thereby pivoting the left pawl 196 about a left pawl pin 306 and compressing the first biasing member 282, such that the first plurality of pawl teeth 252 do not mesh with the plurality of drive teeth 228. Therefore, the right pawl 200 is configured to engage the second plurality of pawl teeth 278 with the plurality of drive teeth 228 to couple the drive 192 for co-rotation with the yoke 188 in the second direction 258 but to permit the yoke 188 to rotate relative to the drive 192 in the first direction 256.

In the second position, the spring 294 of the shuttle assembly 204 urges the pushing member 298 into engagement with a portion 310 of the right pawl 200, thereby pivoting the right pawl 200 about a right pawl pin 314 and compressing the second biasing member 286, such that the second plurality of pawl teeth 278 do not mesh with the plurality of drive teeth 228. Therefore, the left pawl 196 is configured to engage the first plurality of pawl teeth 252 with the plurality of drive teeth 228 to couple the drive 192 for co-rotation with the yoke 188 in the first direction 256 but to permit the yoke 188 to rotate relative to the drive 192 in the second direction 258.

In operation, the user depresses the switch paddle 126a and the switch 124 to permit the flow of current from the battery pack to the motor 116. The motor 116 may then transmit torque (via the drive assembly 128) to the crankshaft 156, thereby causing the crankshaft 156 to rotate about the first axis A. The eccentric pin 180, centered around the second axis B and rotating about the first axis A, causes the yoke 188 to reciprocate about the third axis C. Depending on the position of the left pawl 196, the right pawl 200, and the shuttle assembly 204, the drive 192 is actuated to rotate in the first direction 256 or the second direction 258. The meshing of the plurality of drive teeth 228 with the first plurality of pawl teeth 252 or the second plurality of pawl teeth 278 allows for rotation about the first direction 256 or the second direction 258. The use of herringbone teeth as the plurality of drive teeth 228, first plurality of pawl teeth 252, and the second plurality of pawl teeth 278 may provide higher strength and torque capabilities compared to straight teeth, while advantageously balancing axial forces that would otherwise be generated by angled teeth.

Various features of the invention are set forth in the following claims.

What is claimed is:

1. A powered ratchet tool comprising:
a housing including a head portion;
a motor;
a drive assembly including an output configured to be driven by the motor;
a yoke supported within the head portion and coupled to the output of the drive assembly such that the yoke is configured to reciprocate about an axis in response to rotation of the output;
a drive supported by the yoke, the drive including a first plurality of herringbone teeth on an outer periphery of the drive; and
a pawl including a second plurality of herringbone teeth configured to engage the first plurality of herringbone teeth to rotate the drive together with the yoke in a first direction about the axis and to slide over the first plurality of herringbone teeth such that the yoke is rotatable relative to the drive in a second direction about the axis.

2. The powered ratchet tool according to claim 1, wherein the first plurality of herringbone teeth includes an upper row of teeth and a lower row of teeth, and wherein the drive includes a groove positioned between the upper and lower rows of teeth.

3. The powered ratchet tool according to claim 2, wherein each tooth of the upper row of teeth defines a first angle with the groove, the first angle being an interior angle measuring less than 90 degrees, wherein each tooth of the lower row of teeth defines a second angle with the groove, the second angle being an interior angle measuring less than 90 degrees.

4. The powered ratchet tool according to claim 3, wherein the first angle and the second angle are equal such that the first and second rows of teeth are symmetrical across the groove.

5. The powered ratchet tool according to claim 1, wherein the second plurality of herringbone teeth includes an upper row of teeth and a lower row of teeth, and wherein the pawl includes a groove positioned between the upper and lower rows of teeth.

6. The powered ratchet tool according to claim 5, wherein each tooth of the upper row of teeth defines a first angle with the groove, the first angle being an interior angle measuring less than 90 degrees, and wherein each tooth of the lower row of teeth forms a second angle with the groove, the second angle being an interior angle measuring less than 90 degrees.

7. The powered ratchet tool according to claim 1, further comprising a second pawl having a third plurality of herringbone teeth configured to selectively engage the first plurality of drive teeth to rotate the drive together with the yoke in the second direction.

8. The powered ratchet tool according to claim 7, further comprising a switch movable to pivot the first pawl or the second pawl out of engagement with the drive.

9. A powered ratchet tool comprising:
a housing including a head portion;
a motor;
a drive assembly including an output configured to be driven by the motor;
a yoke supported within the head portion and coupled to the output of the drive assembly such that the yoke is configured to reciprocate about an axis in response to rotation of the output;
a drive supported by the yoke, the drive including a first plurality of herringbone teeth on an outer periphery of the drive;
a first pawl including a second plurality of herringbone teeth configured to engage the first plurality of herringbone teeth to rotate the drive together with the yoke in a first direction about the axis; and
a second pawl including a third plurality of herringbone teeth configured to engage the first plurality of herringbone teeth to rotate the drive together with the yoke in a second direction about the axis.

10. The powered ratchet tool according to claim 9, further comprising a knob coupled to a pushing member, the pushing member configured to engage the first pawl or the second pawl with the drive.

11. The powered ratchet tool according to claim 10, wherein the knob extends outside the housing and is configured to be actuated by a user.

12. The powered ratchet tool according to claim 11, wherein the knob is rotatable between a first position or a second position.

13. The powered ratchet tool according to claim 12, wherein the first position allows the pushing member to engage the first pawl, preventing the first pawl from engaging with the drive and allowing the second pawl to engage with the drive.

14. The powered ratchet tool according to claim 12, wherein the second position allows the pushing member to engage with the second pawl, preventing the second pawl from engaging with the drive and allowing the first pawl to engage with the drive.

15. The powered ratchet tool according to claim 9, wherein the first plurality of herringbone teeth includes a first row of teeth and a second row of teeth.

16. The powered ratchet tool of claim 15, wherein the first row of teeth and the second row of teeth are symmetrical.

17. A powered ratchet tool comprising:
a housing including a head portion;
a motor;
a drive assembly including an output configured to be driven by the motor;
a yoke supported within the head portion and coupled to the output of the drive assembly such that the yoke is configured to reciprocate about an axis in response to rotation of the output;
a drive supported by the yoke, the drive including a first plurality of herringbone teeth on an outer periphery of the drive and an interior defining an insertion hole, the insertion hole being a through-hole extending entirely through the drive; and
a first pawl including a second plurality of herringbone teeth configured to engage the first plurality of herringbone teeth to rotate the drive together with the yoke in a first direction about the axis.

18. The powered ratchet tool according to claim 17, wherein the insertion has a hexagonal cross-section.

19. The powered ratchet tool according to claim 17, wherein the insertion hole is configured to receive an accessory that is engageable with and drives a fastener.

20. The powered ratchet tool according to claim 17, further comprising a second pawl including a third plurality of herringbone teeth configured to engage the first plurality of herringbone teeth to rotate the drive together with the yoke in a second direction about the axis.
